(19) United States
(12) Patent Application Publication
(10) Pub. No.: US 2014/0049035 A1
(43) Pub. Date: Feb. 20, 2014

(54) PIPE COUPLER CLAMP

(71) Applicants: Christopher Stewart, San Diego, CA (US); Randy Norman, San Diego, CA (US)

(72) Inventors: Christopher Stewart, San Diego, CA (US); Randy Norman, San Diego, CA (US)

(21) Appl. No.: 13/589,915

(22) Filed: Aug. 20, 2012

(51) Int. Cl. F16L 55/00; B23P 11/00

(52) U.S. Cl. 285/39; 29/428

(57) ABSTRACT

A clamp (12) is usable with a pipe assembly (10) including a first pipe segment (14A), a second pipe segment (14B) and a coupler (16) that couples together the pipe segments (14A, 14B), the coupler including a coupler engagement member (20). The clamp (12) comprises a first clamp section (28) that selectively engages the coupler (16), and a second clamp section (30) that selectively engages the coupler (16). The second clamp section (30) is coupled to and movable relative to the first clamp section (28). Further, at least one of the first clamp section (28) and the second clamp section (30) includes a clamp engagement member (42) that engages the coupler engagement member (20) of the coupler (16). In one embodiment, the coupler engagement member (20) includes a groove and the clamp engagement member (42) includes a projection that fits within and engages the groove.

### BACKGROUND

Pipe assemblies are often used to provide a reliable means for moving fluids, e.g., water, glycol, other liquids, etc., potentially lengthy distances from one place to another. Such pipe assemblies can include a plurality of pipe segments, and a plurality of couplers that are used to couple adjacent pipe segments together. The couplers can be secured to the pipe segments through the use of one or more coupler connectors, e.g., bolts, screws, etc. During prolonged and continuous use of the pipe assemblies, the coupler connectors can experience wear, failure, or otherwise experience conditions where repair or replacement of the coupler connectors is required. Unfortunately, removal, repair and/or replacement of the coupler connectors can require the entire pipe assembly to be shut down for a period of time, which can prove to be very costly to the operators of the pipe assemblies.

### SUMMARY

The present invention is directed toward a clamp for use with a pipe assembly including a first pipe segment, a second pipe segment and a coupler that couples together the first pipe segment and the second pipe segment, the coupler including a coupler engagement member. In certain embodiment, the clamp comprises a first clamp section and a second clamp section. The first clamp section selectively engages the coupler. Additionally, the second clamp section selectively engages the coupler. The second damp section is coupled to and movable relative to the first clamp section. Further, at least one of the first clamp section and the second clamp section includes a clamp engagement member that engages the coupler engagement member of the coupler.

In one embodiment, the coupler engagement member includes a groove and the clamp engagement member includes a projection that fits within and engages the groove.

In some embodiments, the first clamp section includes a first clamp engagement member and the second clamp section includes a second clamp engagement member. In one such embodiment, the coupler includes a first coupler engagement member and a second coupler engagement member. Additionally, in such embodiment, the first clamp engagement member can engage the first coupler engagement member and the second clamp engagement member can engage the second coupler engagement member.

Further, in some embodiments, the first clamp section includes a first clamp engagement member and a second clamp engagement member, and the second clamp section includes a third clamp engagement member and a fourth clamp engagement member. In one such embodiment, the coupler includes a first coupler engagement member, a second coupler engagement member, a third coupler engagement member and a fourth coupler engagement member. Additionally, in such embodiment, the first clamp engagement member can engage the first coupler engagement member, the second clamp engagement member can engage the second coupler engagement member, the third clamp engagement member can engage the third coupler engagement member, and the fourth clamp engagement member can engage the fourth coupler engagement member.

Additionally, in certain embodiments, the clamp further comprises a clamp frame that adjustably couples the first clamp section and the second clamp section. Moreover, in one embodiment, the clamp further comprises a clamp adjuster that selectively adjusts the position of the first clamp section relative to the second clamp section. Further, the clamp frame can include a frame aperture such that the clamp adjuster extends through the frame aperture.

In one embodiment, the clamp further comprises (i) a first clamp arm that includes the first clamp section, (ii) a second clamp arm that includes the second clamp section, and (iii) a connector that movably couples the first clamp arm and the second clamp arm.

Additionally, the present invention is further directed toward a method for securing a coupler to a first pipe segment and an adjacent second pipe segment during removal of one or more coupler connectors, the coupler including a coupler engagement member, the method comprising the steps of (i) selectively engaging the coupler with a first clamp section; (ii) selectively engaging the coupler with a second clamp section, the second clamp section being coupled to and movable relative to the first clamp section, wherein at least one of the first clamp section and the second clamp section includes a clamp engagement member; and (iii) positioning the clamp sections so the clamp engagement member engages the coupler engagement member.

### BRIEF DESCRIPTION OF THE DRAWINGS

The novel features of this invention, as well as the invention itself, both as to its structure and its operation, will be best, understood from the accompanying drawings, taken in conjunction with the accompanying description, in which similar reference characters refer to similar parts, and in which:

FIG. 1A is a simplified illustration of a pipe assembly with a portion of the pipe assembly being illustrated in phantom, and one embodiment of a clamp having features of the present invention, the clamp being illustrated in a disengaged position;

FIG. 1B is a simplified end view of the pipe assembly and the clamp illustrated in FIG. 1A, the clamp being illustrated in an engaged position with a portion of the clamp being illustrated in phantom;

FIG. 1C is a simplified side view of the pipe assembly, with a portion of the pipe assembly being illustrated in phantom, and the clamp illustrated in FIG. 1A, the clamp being illustrated in the engaged position;

FIG. 2 is a simplified front view of another embodiment of the clamp having features of the present invention; and

FIG. 3 is a simplified front view of still another embodiment of the clamp having features of the present invention,

### DESCRIPTION

As provided in detail herein below, the present invention is directed toward a clamp that is usable with a pipe assembly. In particular, the clamp is designed to hold a coupler of the pipe assembly securely in position relative to adjacent pipe segments of the pipe assembly during removal, repair and/or replacement of one or more coupler connectors that are utilized to secure the coupler to the pipe segments during regular usage of the pipe assembly. Additionally, as provided herein, the coupler can include one or more coupler engagement members and the clamp can include one or more clamp engagement members that are adapted to engage one another during removal, repair and/or replacement of one or more of the coupler connectors. The designs provided herein enable for relatively quick and easy removal, repair and/or replacement of the coupler connectors without the need to shut down the pipe assembly, and without the interruption of proper functioning of the pipe assembly that may otherwise occur.

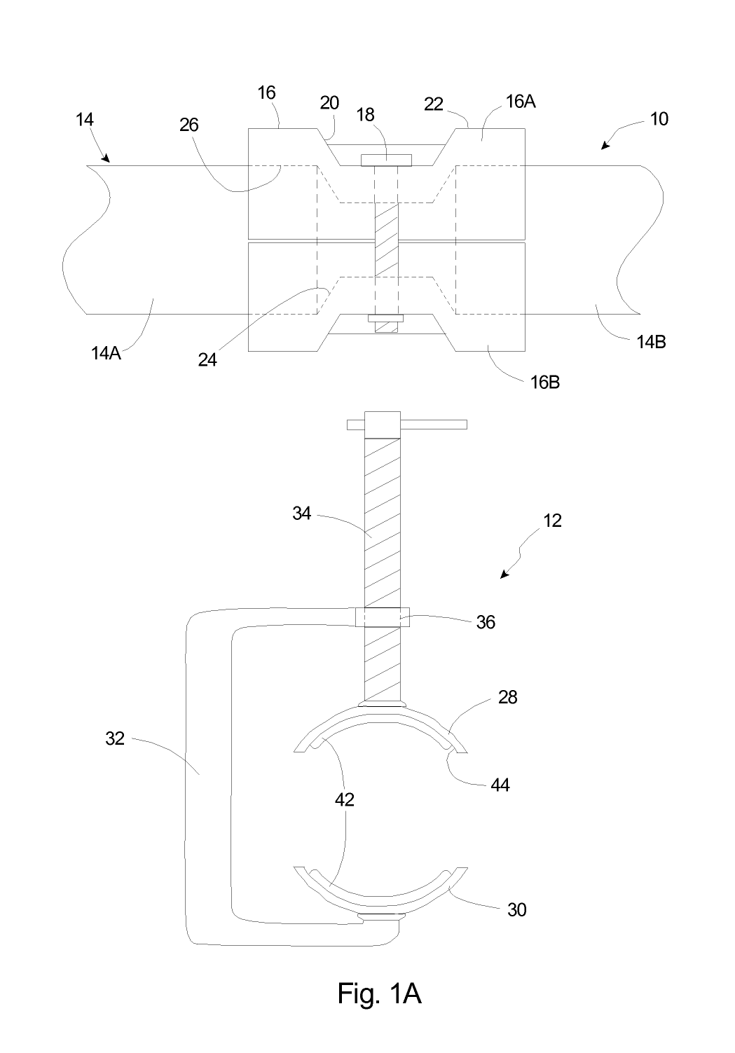

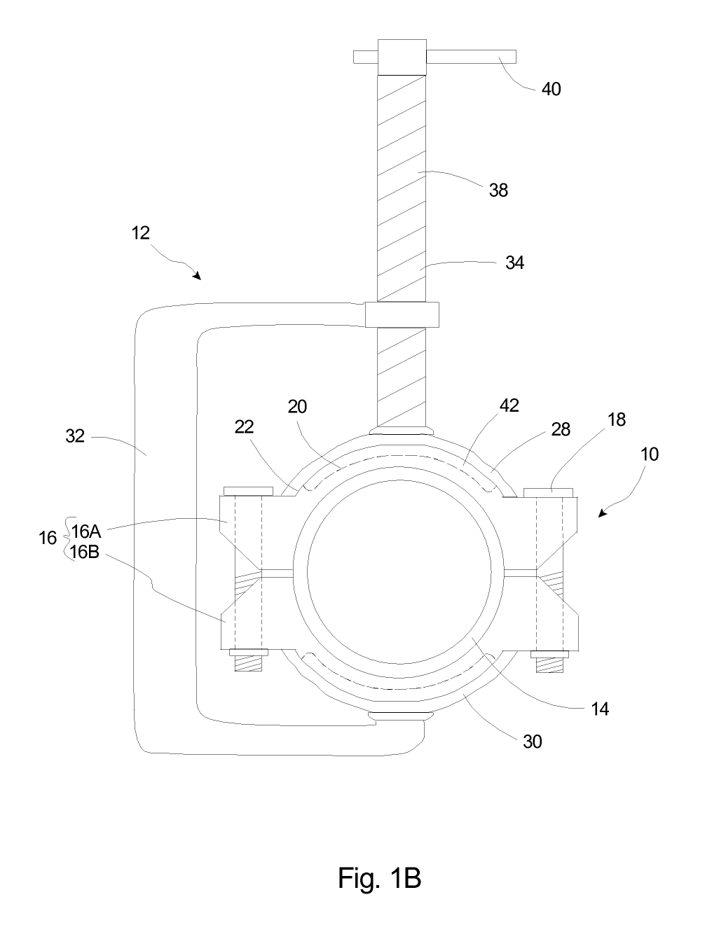

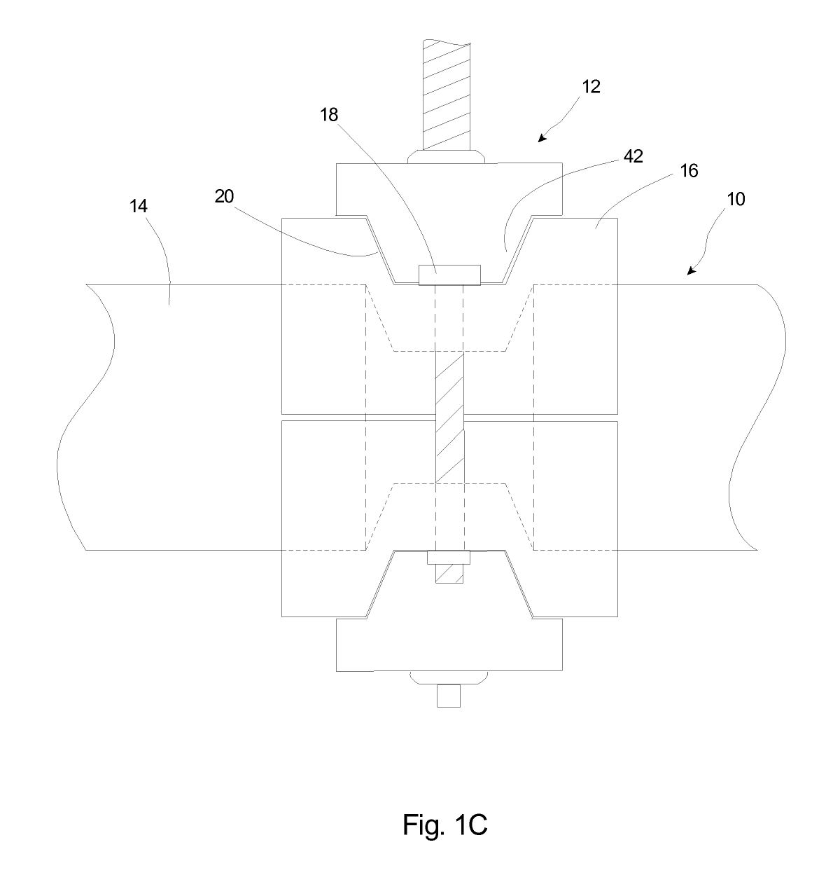

FIG. 1A is a simplified illustration of a pipe assembly 10 and an embodiment of a clamp 12 having features of the present invention. In certain embodiments, the clamp 12 is movable between a disengaged position (illustrated in FIG. 1A) and an engaged position (illustrated in FIGS. 1B and 1C). When in the disengaged position, the clamp 12 is spaced apart from the pipe assembly 10. Conversely, when in the engaged position, the clamp 12 is in contact with the pipe assembly 10.

The pipe assembly 10 is typically used as a conduit for moving fluids from one place to another. In certain embodiments, the pipe assembly 10 can be used in commercial structures, e.g., hotels, office buildings, or other types of commercial structures, for moving suitable fluids, e.g., water, glycol, other liquids, etc., from one place to another within the commercial structure or between the commercial structure and a location outside of the commercial structure. Alternatively, the pipe assembly 10 can be utilized for other appropriate uses,

As illustrated, the pipe assembly 10 can include a plurality of pipe segments 14 (two are illustrated in FIG. 1A) and one or more couplers 16 (only one is illustrated in FIG. 1A). The pipe segments 14, e.g., a first pipe segment 14A and a second pipe segment 14B, encompass the majority of the length of the pipe assembly 10. The pipe segments 14 can be of any suitable lengths depending on the desired length of the pipe assembly 10. In certain embodiments, each pipe segment 14 can be between approximately six inches and 40 feet in length. Alternatively, the pipe segments 14 can be longer or shorter than the lengths specifically noted above.

Additionally, in some embodiments, the pipe segments 14 can be substantially straight and have a substantially circular cross-section. Additionally, and/or alternatively, the pipe segments 14 can include angled regions that enable the pipe assembly 10 to extend in different desired directions. Still alternatively, the pipe segments 14 can have other than a substantially circular cross-section.

Further, the pipe segments 14 can be made from various materials. For example, the pipe segments 14 can be made from steel, iron, or various other metals or metal alloys. Alternatively, one or more other suitable non-metal materials may also be used.

The couplers 16 couple together adjacent pipe segments 14. Additionally, the couplers 16 extend around and engage a portion of an outer surface of adjacent pipe segments 14. Further, as illustrated in FIG. 1A, the coupler 16 can be secured about a portion of adjacent pipe segments 14 with one or more coupler connectors 18 (only one coupler connector 18 is illustrated in FIG. 1A), thereby coupling together and securing the adjacent pipe segments 14 to one another.

The design of the couplers 16 can be varied to suit the design requirements of the pipe assembly 10. In certain embodiments, each of the couplers 16 includes an upper coupler section 16A (also referred to herein as a “first coupler section”) and a lower coupler section 16B (also referred to herein as a “second coupler section”). Moreover, the coupler connectors 18 are utilized to connect the first coupler section 16A to the second coupler section 16A when the coupler sections 16A, 16B are positioned about the pipe segments 14. Alternatively, one or more of the couplers 16 can have a different design.

It should be noted that the use of the terms “first coupler section” and “second coupler section” is merely for ease of description, and either coupler section 16A, 16B can be referred to as the “first coupler section” and/or the “second coupler section”.

Additionally, as illustrated in FIG. 1A, each of the couplers 16 includes one or more coupler engagement members 20. The design of the coupler engagement members 20 can be varied. For example, in one non-exclusive embodiment, the coupler engagement members 20 can comprise and/or include a channel or groove that manufactured into an outer surface 22 (e.g., a rounded outer surface) of the coupler 16, e.g., into an outer surface of the first coupler section 16A and/or the second coupler section 16B. Alternatively, the coupler engagement members 20 can have a different design. For example, in one non-exclusive alternative embodiment, the coupler engagement members 20 can comprise and/or include a projection that is manufactured onto the outer surface 22 of the coupler 16, e.g., onto the outer surface of the first coupler section 16A and/or the second coupler section 16B. Still alternatively, a combination of such designs can be used and/or the coupler engagement members 20 can have another suitable design.

In certain embodiments, the coupler engagement members 20 can extend in a longitudinal or lengthwise direction as the coupler sections 16A, 16B extend partially or fully around the perimeter, e.g., the circumference, of the pipe segments 14. Further, the coupler engagement members 20 can extend substantially the entire length of the coupler section 16A, 16B, or the coupler engagement members 20 can extend less than the entire length of the coupler section 16A, 16B. Still further, each coupler section 16A, 16B can include multiple coupler engagement members 20 that cooperate to extend substantially the entire length of the coupler section 16A, 16B, or less than the entire length of the coupler section 16A, 16B. Alternatively, the coupler engagement members 20 can extend in a different direction. For example, the coupler engagement members 20 can extend substantially transversely to the length of the coupler section 16A, 16B, or the coupler engagement members 20 can extend at an angle relative to the length of the coupler section 16A, 16B.

In some embodiments, the coupler engagement members 20 are utilized to reduce the amount of material that is necessary to form the couplers 16 (while still maintaining the necessary strength characteristics), thus enabling the couplers 16 to have reduced weight.

Moreover, are provided in detail herein, during an operation to remove, repair and/or replace one or more of the coupler connectors 18, the coupler engagement members 20 can be utilized to engage a portion of the clamp 12. By having the coupler engagement members 20 engage a portion of the clamp 12, the clamp 12 can be more securely positioned about the coupler 16 during any operations to remove, repair and/or replace one or more of the coupler connectors 18. Further, the engagement between the coupler engagement members 20 and the portion of the clamp 12 can inhibit movement of the clamp 12 relative to the coupler 16 during such operations.

Referring now to FIG. 18, FIG. 18 is a simplified end view of the pipe assembly 10 and the clamp 12 illustrated in FIG. 1A, the clamp 12 being in the engaged position. As shown in this embodiment, when the coupler 16, i.e. the coupler sections 16A, 16B, is positioned about the pipe segments 14, the coupler 16 has a substantially circular cross-section that corresponds with the substantially circular cross-section of the pipe segments 14. Alternatively, if the pipe segments 14 have a different cross-sectional shape, the coupler 16 can also be designed to have a different cross-sectional shape that matches the shape of the pipe segments 14.

Referring back to FIG. 1A, as illustrated, the coupler 16 can include one or more aligners 24 (illustrated in phantom) that assist in ensuring the proper alignment of the pipe segments 14 within the coupler 16. For example, in this embodiment, the aligners 24 can comprise and/or include one or more raised sections that project away from an inner surface 26 of the coupler sections 16A, 16B. Additionally, with this design, the aligners 24 narrow the area within the coupler 16 such that the pipe segments 14 can only extend a certain distance within the coupler 16, i.e. the pipe segments are inhibited from extending fully through the coupler 16. Moreover, as illustrated, the aligners 24 function to maintain the pipe segments 14 spaced apart from one another as they are positioned within the coupler 16. By only allowing the pipe segments 14 to extend a certain distance within the coupler 16, and by thus maintaining the pipe segments 14 spaced apart from one another, the aligners 24 are able to effectively align the pipe segments 14 with one another to promote better and more efficient flow of the fluids within the pipe assembly 10.

As provided above, the coupler connectors 18 are utilized to connect the first coupler section 16A to the second coupler section 16A when the coupler sections 16A, 16B are positioned about the pipe segments 14. The design of the coupler connectors 18 can be varied. In one embodiment, the coupler connectors 18 can be high strength bolts or screws that can be secured, i.e. tightened, with a nut when the coupler sections 16A, 16B are positioned about the pipe segments 14. Additionally, the coupler connectors 18 can be made from iron, steel, or another suitable material. Alternatively, the coupler connectors 18 can have another suitable design.

The number of coupler connectors 18 that are utilized for each coupler 16 can be varied. In one embodiment, the coupler 16 can utilize two coupler connectors 18 (see FIG. 1B), with one coupler connector 18 being positioned on either side of the coupler 16. Alternatively, the coupler 16 can be designed to use more than two coupler connectors 18 or only one coupler connector 18. For example, in one non-exclusive alternative embodiment, four coupler connectors 18 can be utilized to connect the first coupler section 16A to the second coupler section 16A, with two coupler connectors 18 being positioned on either side of the coupler 16.

As stated above, the clamp 12 is designed to hold the coupler 16 of the pipe assembly 10 securely in position relative to adjacent pipe segments 14 of the pipe assembly 10 during removal, repair and/or replacement of one or more coupler connectors 18 that are utilized to secure the coupler 16 to the pipe segments 14 during regular usage of the pipe assembly 10.

The design of the clamp 12 can be varied, e.g., to suit the particular requirements of the pipe assembly 10 and/or the coupler 16. In one embodiment, as illustrated in FIG. 1A, the clamp 12 can be a C-type clamp including a first clamp section 28, a second clamp section 30, a clamp frame 32, and a clamp adjuster 34. Alternatively, the clamp 12 can have a different design.

The first clamp section 28 selectively engages the coupler 16, i.e. as the clamp 12 moves from the disengaged position to the engaged position. Additionally, as illustrated, the first clamp section 28 can be curved so as to correspond and/or be substantially complementary with a portion of the outer surface 22 of the coupler 16. Alternatively, the first clamp section 28 can have a different shape that corresponds with a shape of a portion of the outer surface 22 of the coupler 16.

Somewhat similarly, the second damp section 30 selectively engages the coupler 16, i.e. as the clamp 12 moves from the disengaged position to the engaged position. Additionally, as illustrated, the second clamp section 30 can also be curved to correspond and/or be substantially complementary with a portion of the outer surface 22 of the coupler 16. Alternatively, the second clamp section 30 can have a different shape that corresponds with a shape of a portion of the outer surface 22 of the coupler 16.

Referring again to FIG. 1B, in one embodiment, the first clamp section 28 can be positioned to selectively engage the first coupler section 16A as the clamp 12 moves from the disengaged position to the engaged position. Moreover, the first clamp section 28 can be curved to correspond with a portion of the outer surface 22 of the first coupler section 16A. Somewhat similarly, in one embodiment, the second clamp section 30 can be positioned to selectively engage the second coupler section 16B as the clamp 12 moves from the disengaged position to the engaged position. Moreover, the second clamp section 30 can be curved to correspond and/or be substantially complementary with a portion of the outer surface 22 of the second coupler section 16B.

It should be noted that the use of the terms “first clamp section” and second clamp section” is merely for ease of description, and either clamp section 28, 30 can be referred to as the “first clamp section” and/or the “second clamp section”.

Referring back to FIG. 1A, the clamp frame 32 adjustably couples and or connects the first clamp section 28 to the second clamp section 30. In this embodiment, the clamp frame 32 is substantially C-shaped. Alternatively, the clamp frame 32 can any other suitable shape.

As shown in the embodiment illustrated in FIG. 1A, the clamp frame 32 includes a frame aperture 36 (illustrated in phantom) that receives a portion of the clamp adjuster 34 to enable the adjustable positioning of the first clamp section 28 relative to the second clamp section 30. In one embodiment, the frame aperture 36 can be internally threaded such that the clamp adjuster 34 can be threaded through the frame aperture 36.

The damp adjuster 34 is usable to selectively adjust the positioning of the clamp 12, i.e. the relative positioning of the first clamp section 28 and the second clamp section 30, as the clamp 12 moves between the disengaged position and the engaged position. Additionally, as illustrated, the clamp adjuster 34 can include a screw 38 that extends through the frame aperture 36, and a handle 40 that enables the user to more easily adjust the positioning of the damp 12, i.e. the positioning of the first clamp section 28 relative to the second clamp section 30. Further, as shown in FIG. 1A, the screw 38 is coupled to the first clamp section 28. During use, the handle 40 can be rotated in either direction, thereby threading the screw 38 more or less through the frame aperture 36, so as to adjust the position of the first clamp section 28 relative to the second clamp section 30. With this design, the clamp 12 can be quickly and easily tightened about the coupler 16 so as to enable the removal, repair and/or replacement of one or more coupler connectors 18, and/or the clamp 12 can be quickly and easily loosened and removed after completion of such operations. Alternatively, the clamp adjuster 34 can have a different design and/or can adjust the position of the first clamp section 28 relative to the second clamp section 30 in another suitable manner.

Moreover, as illustrated in FIG. 1A, the clamp 12 can include one or more clamp engagement members 42 that are adapted to engage the one or more coupler engagement members 20 of the coupler 16. The design of the clamp engagement members 42 can be varied. For example, in certain non-exclusive embodiments, each of the clamp engagement members 42 can comprise and/or include a projection or protrusion that extends outwardly from a surface 44 of the first clamp section 28 and/or the second clamp section 30. With this design, the clamp engagement members 42 can be fitted within the coupler engagement members 20, e.g., when the coupler engagement members 20 comprise and/or include a channel or groove-type design, to engage the coupler engagement members 20. In one such embodiment, as illustrated in FIG. 1B, each of the clamp engagement members 42 can be designed to extend substantially fully within and engage the entirety of one of the coupler engagement members 20. Alternatively, in another such embodiment, one or more of the clamp engagement members 42 can extend substantially within and engage less than the entirety of one of the coupler engagement members 20.

Still alternatively, each of the clamp engagement members 42 can include a channel, indentation or groove that is manufactured into the surface 44 the first clamp section 28 and/or the second clamp section 30. With this design, the coupler engagement members 20, e.g., when the coupler engagement members 20 comprise and/or include a projection-type design, can be fitted within and/or be substantially complementary to the clamp engagement members 42. In one such embodiment, each of the coupler engagement members 20 can be designed to extend substantially fully within and engage the entirety of one of the clamp engagement members 42. In another such embodiment, one or more of the coupler engagement members 20 can extend substantially within and engage less than the entirety of one of the clamp engagement members 42. Additionally and/or alternatively, a combination of such designs can be used for the clamp engagement members 42 and/or the clamp engagement members 42 can have another suitable design.

It should be noted that the size of the coupler engagement members 20 and the clamp engagement members 42 can be varied, and the size of the coupler engagement members 20 and the clamp engagement members 42 as illustrated in the Figures is not intended to be limiting in any manner, nor are they necessarily representative of the actual size or scale of those components. For example, the size of the coupler engagement members 20 and the clamp engagement members 42 may be smaller than that shown, but such sizes have been presented in this manner so that the engagement between the coupler engagement members 20 and the clamp engagement members 42 can be more clearly illustrated.

FIG. 1C is a simplified side view of the pipe assembly 10 and the clamp 12 illustrated in FIG. 1A, with the clamp 12 shown in the engaged position. As shown, the clamp engagement members 42 engage the coupler engagement members 20 so as to enable the clamp 12 to hold the coupler 16 of the pipe assembly 10 securely in position relative to adjacent pipe segments 14 of the pipe assembly 10 during removal, repair and/or replacement of one or more coupler connectors 18. In particular, in this embodiment, the clamp engagement members 42 are projection-type members that are adapted to fit within and extend substantially the entire length of the channel or groove-type coupler engagement members 20.

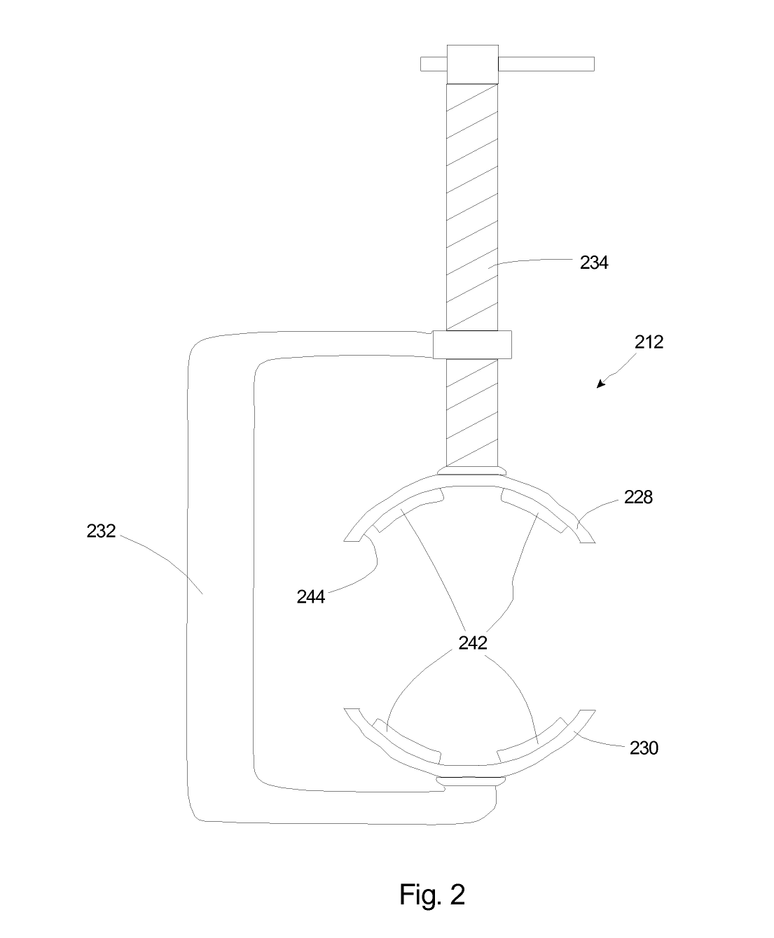

FIG. 2 is a simplified front view of another embodiment of a clamp 212 having features of the present invention. The design of the clamp 212 is substantially similar to the design of the clamp 12 illustrated and described above in relation to FIGS. 1A-1C. For example, the clamp is again a C-type clamp including a first clamp section 228, a second clamp section 230, a clamp frame 232, and a clamp adjuster 234 that are substantially similar to the first clamp section 28, the second clamp section 30, the clamp frame 32, and the clamp adjuster 34 illustrated and described above in relation to FIGS. 1A-1C. Accordingly, a detailed description of the first clamp section 228, the second clamp section 230, the clamp frame 232, and the clamp adjuster 234 will not be provided.

Additionally, as illustrated in FIG. 2, the clamp 212 again includes one or more clamp engagement members 242 that are adapted to engage the one or more coupler engagement members 20 (illustrated in FIG. 1A) of the coupler 16 (illustrated in FIG. 1A). However, in this embodiment, the design of the clamp engagement members 242 has been varied slightly from the previous embodiment. In this embodiment, each of the clamp engagement members 242 again includes a projection that is manufactured onto a surface 244 of the first clamp section 228 and/or the second clamp section 230. However, each of the clamp engagement members 242 is somewhat shorter in length such that the clamp engagement members 242 do not extend substantially the entire length of the channel or groove-type coupler engagement members 20, and/or the clamp engagement members 242 are able to effectively engage coupler engagement members 20 that are much shorter in length than those specifically illustrated in FIG. 1B. Stated in another fashion, each of the clamp engagement members 242 are much shorter than the length of the corresponding clamp section 228, 230, i.e. each of the clamp engagement members 242 is less than half the length of the corresponding clamp section 228, 230.

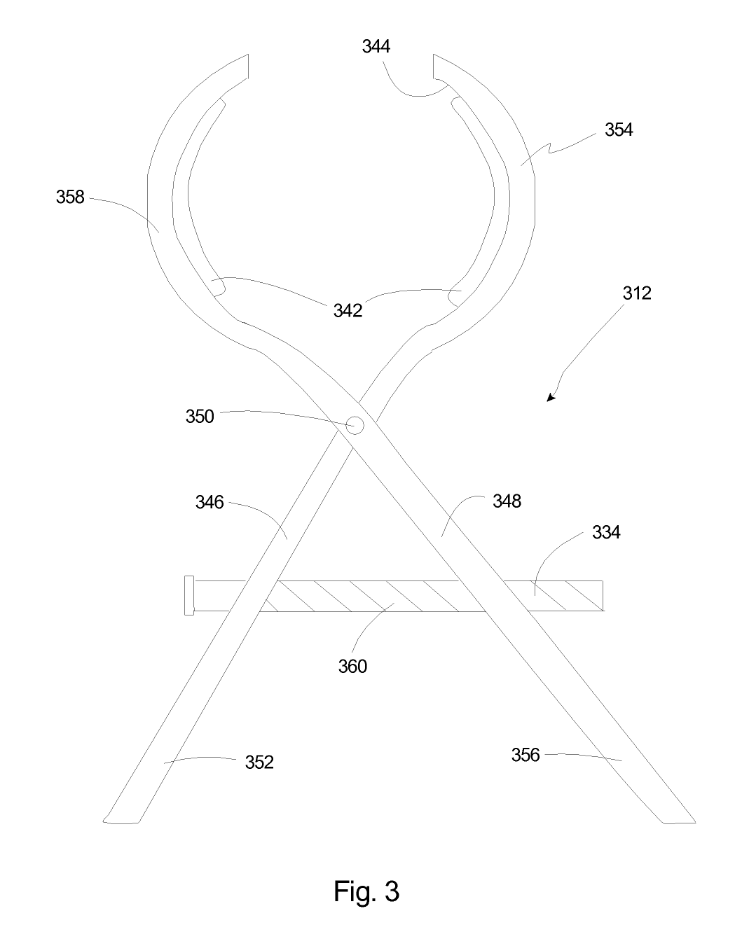

FIG. 3 is a simplified front view of still another embodiment of a clamp 312 having features of the present invention. In this embodiment, the clamp 312 includes a first clamp arm 346, a second clamp arm 348, a pivot connector 350 (also referred to herein simply as a “connector”), and a clamp adjuster 334.

The first clamp arm 346 includes a first grip region 352 and a first clamp section 354. The first grip region 352 is designed to be grasped or otherwise handled by the user. The first clamp section 354 is adapted to engage the coupler 16 (illustrated in FIG. 1A) of the pipe assembly 10 (illustrated in FIG. 1A). More particularly, the first clamp section 354 can be curved so as to correspond with a portion of the outer surface 22 (illustrated in FIG. 1A) of the coupler 16, e.g., the outer surface 22 of the first coupler section 16A (illustrated in FIG. 1A).

Somewhat similarly, the second clamp arm 346 includes a second grip region 356 and a second clamp section 358. The second grip region 356 is designed to be grasped or otherwise handled by the user. The second clamp section 358 is adapted to engage the coupler 16 of the pipe assembly 10. More particularly, the second clamp section 358 can be curved so as to correspond with a portion of the outer surface 22 of the coupler 16, e.g., the outer surface 22 of the second coupler section 16B (illustrated in FIG. 1A).

The connector 350 pivotally and/or movably couples the first clamp arm 346 and the second clamp arm 348. In one embodiment, the connector 350 can be a pin that extends through the first clamp arm 346 and the second clamp arm 348 to enable the first clamp arm 346 and the second clamp arm 348 to pivot relative to one another. Alternatively, the connector 350 can have a different design.

The clamp adjuster 334 is somewhat similar in design and function to the clamp adjusters 34, 234 illustrated and described above. As illustrated in this embodiment, the clamp adjuster 334 can include a screw 360 that extends through the first clamp arm 346 and the second clamp arm 348 to enable the first clamp arm 346 and the second clamp arm 348 to pivot relative to one another. In particular, during use, the screw 360 can be rotated and thus threaded through one or both of the first clamp arm 346 and the second clamp arm 348. In one embodiment, the screw 360 can be fixedly secured to the first clamp arm 346 and adjustably secured, i.e. threaded, to the second clamp arm 348. Alternatively, the screw 360 can be fixedly secured to the second clamp arm 348 and adjustably secured, i.e. threaded, to the first clamp arm 346. Still alternatively, the screw 360 can be adjustably secured to both of the first damp arm 346 and the second clamp arm 348. As the screw 360 is rotated and thus threaded through one or both of the first damp arm 346 and the second clamp arm 348, the clamp arms 346, 348 pivot relative to one another about the connector 350, and the first clamp section 354 and the second clamp section 358 move relative to one another, i.e., either closer to one another or farther apart from one another depending on the direction of rotation of the screw 360. With this design, the clamp 312 can be quickly and easily tightened about the coupler 16 so as to enable the removal, repair and/or replacement of one or more coupler connectors 18 (illustrated in FIG. 1A); and/or the clamp 312 can be quickly and easily loosened and removed after completion of such operations. Alternatively, the clamp adjuster 334 can have a different design and/or can adjust the position of the first clamp section 354 relative to the second clamp section 358 in a different manner.

Additionally, as illustrated in FIG. 3, the clamp 312 again includes one or more clamp engagement members 342 that are adapted to engage the one or more coupler engagement, members 20 (illustrated in FIG. 1A) of the coupler 16. The design of the clamp engagement members 342 can be substantially similar to or different than the clamp engagement members 42, 242 illustrated and described above. For example, in certain non-exclusive embodiments, each of the clamp engagement members 342 can comprise and/or include a projection that is manufactured onto a surface 344 of the first clamp section 354 and/or the second clamp section 358. With this design, the clamp engagement members 342 can be fitted within the coupler engagement members 20, e.g., when the coupler engagement members 20 comprise and/or include a channel or groove-type design, to engage the coupler engagement members 20. In one such embodiment, each of the clamp engagement members 342 can be designed to extend substantially fully within and engage the entirety of one of the coupler engagement members 20. Alternatively, in another such embodiment, one or more of the clamp engagement members 342 can extend substantially within and engage less than the entirety of one of the coupler engagement members 20.

Still alternatively, each of the clamp engagement members 342 can comprise and/or include a channel or groove that is manufactured into the surface 344 the first clamp section 354 and/or the second clamp section 358. With this design, the coupler engagement members 20, e.g., when the coupler engagement members 20 comprise and/or include a projection-type design, can be fitted within the clamp engagement members 342. In one such embodiment, each of the coupler engagement members 20 can be designed to extend substantially fully within and engage the entirety of one of the clamp engagement members 342. In another such embodiment, one or more of the coupler engagement members 20 can extend substantially within and engage less than the entirety of one of the clamp engagement members 342. Additionally and/or alternatively, a combination of such designs can be used for the clamp engagement members 342 and/or the clamp engagement members 342 can have another suitable design.

It is understood that the clamp disclosed herein can be configured in various other suitable ways in addition to those illustrated and described herein. As non-exclusive examples, locking pliers, vices, C-clamps and other suitable designs and configurations fall within the scope of the clamp disclosed herein.

While a number of exemplary aspects and embodiments of a clamp 12 have been discussed above, those skilled in the art will recognize certain modifications, permutations, additions and sub-combinations thereof. It is therefore intended that the following appended claims and claims hereafter introduced are interpreted to include all such modifications, permutations, additions and, sub-combinations as are within their true spirit and scope.

What is claimed is:

1. A clamp for use with a pipe assembly, the pipe assembly including a first pipe segment, a second pipe segment and a coupler that couples together the first pipe segment and the second pipe segment, the coupler including a coupler engagement member, the clamp comprising:
a first clamp section that selectively engages the coupler;
a second clamp section that selectively engages the coupler, the second clamp section being coupled to and movable relative to the first clamp section, wherein at least one of the first clamp section and the second clamp section includes a clamp engagement member that engages the coupler engagement member of the coupler.

2. The clamp of claim 1 wherein the coupler engagement member includes a groove and the clamp engagement member includes a projection that fits within and engages the groove.

3. The clamp of claim 1 wherein the first clamp section includes a first clamp engagement member and the second clamp section includes a second clamp engagement member.

4. The clamp of claim 3 wherein the coupler includes a first coupler engagement member and a second coupler engagement member, and wherein the first clamp engagement member engages the first coupler engagement member and the second clamp engagement member engages the second coupler engagement member.

5. The clamp of claim wherein the first clamp section includes a first clamp engagement member and a second clamp engagement member, and wherein the second clamp section includes a third clamp engagement member and a fourth clamp engagement member.

6. The clamp of claim 5 wherein the coupler includes a first coupler engagement member, a second coupler engagement member, a third coupler engagement member and a fourth coupler engagement member; and wherein the first clamp engagement member engages the first coupler engagement member, the second clamp engagement member engages the second coupler engagement member, the third clamp engagement member engages the third coupler engagement member, and the fourth clamp engagement member engages the fourth coupler engagement member

7. The clamp of claim 1 further comprising a clamp frame that adjustably couples the first clamp section and the second clamp section.

8. The clamp of claim 1 further comprising a clamp adjuster that selectively adjusts the position of the first clamp section relative to the second clamp section.

9. The clamp of claim 8 further comprising a clamp frame that couples the first clamp section and the second clamp section, the clamp frame including a frame aperture, and wherein the clamp adjuster extends through the frame aperture.

10. The clamp of claim 1 further comprising (i) a first clamp arm that includes the first clamp section, (ii) a second clamp arm that includes the second clamp section, and (iii) a connector that movably couples the first clamp arm and the second clamp arm.

11. A method for securing a coupler to a first pipe segment and an adjacent second pipe segment during removal of one or more coupler connectors, the coupler including a coupler engagement member, the method comprising the steps of:
selectively engaging the coupler with a first clamp section;
selectively engaging the coupler with a second clamp section, the second clamp section being coupled to and movable relative to the first clamp section, wherein at least one of the first clamp section and the second clamp section includes a clamp engagement member; and
positioning the clamp sections so the clamp engagement member engages the coupler engagement member.

12. The method of claim 11 wherein the coupler engagement member includes a groove and the clamp engagement member includes a projection, and wherein the step of positioning includes fitting the projection within the groove.

13. The method of claim 11 wherein the step of selectively engaging the coupler with the first clamp section includes the first clamp section having a first clamp engagement member, and wherein the step of selectively engaging the coupler with the second clamp section includes the second clamp section having a second clamp engagement member.

14. The method of claim 13 wherein the coupler includes a first coupler engagement member and a second coupler engagement member, and wherein the step of positioning includes engaging the first coupler engagement member with the first clamp engagement member, and engaging the second coupler engagement member with the second clamp engagement member.

15. The method of claim 11 wherein the step of selectively engaging the coupler with the first clamp section includes the first clamp section having a first clamp engagement member and a second clamp engagement member, and wherein the step of selectively engaging the coupler with the second clamp section includes the second clamp section having a third clamp engagement member and a fourth clamp engagement member.

16. The method of claim 15 wherein the coupler includes a first coupler engagement member, a second coupler engagement member, a third coupler engagement member and a fourth coupler engagement member; and wherein the step of positioning includes engaging the first coupler engagement member with the first clamp engagement member, engaging the second coupler engagement member with the second clamp engagement member, engaging the third coupler engagement member with the third clamp engagement member, and engaging the fourth coupler engagement member with the fourth clamp engagement member.

17. The method of claim 11 further comprising the step of adjustably coupling the first clamp section and the second clamp section with a clamp frame.

18. The method of claim 11 further comprising the step of selectively adjusting the position of the first clamp section relative to the second clamp section with a clamp adjuster.

19. The method of claim 18 further comprising the steps of coupling the first clamp section and the second clamp section with a clamp frame, the clamp frame including a frame aperture; and extending the clamp adjuster through the frame aperture.

20. The method of claim 11 further comprising the step of movably coupling a first clamp arm and a second clamp arm with a connector, the first clamp arm including the first clamp section and the second clamp arm including the second clamp section.
